(19) United States
(12) Patent Application Publication
(10) Pub. No.: US 2009/0005220 A1
(43) Pub. Date: Jan. 1, 2009

(54) Mobile Communication Terminal Having Exercise Quantity Measurement Function and Method of Measuring Exercise Quantity Using the Same

(75) Inventors: Tae-soo Lee, Chungcheongbuk-do (KR); Joo-hyun Hong, Seoul (KR); Nam-jin Kim, Chungcheongnam-do (KR); Min-hwa Lee, Seoul (KR)

Correspondence Address: OBLON, SPIVAK, MCCLELLAND MAIER & NEUSTADT, P.C., 1940 DUKE STREET, ALEXANDRIA, VA, 22314, US

(73) Assignees: HEALTHPIA CO., LTD., Wonju-si (KR); CBNU Industry-Academic Cooperation Foundation, Cheongu (KR)

(21) Appl. No.: 11/813,290

(22) PCT Filed: Jan. 28, 2005
(86) PCT No.: PCT/KR2005/000267

§ 371 Date: Jul. 3, 2007

(30) Foreign Application Priority Data
Jan. 4, 2005 (KR) 10-2005-0000575

(51) Int. Cl. A63B 24/00; A63B 26/00; G01P 15/00

(52) U.S. Cl. 482/8; 73/514.01; 455/73

(57) ABSTRACT

Disclosed is a method of measuring the amount of exercise using a mobile communication terminal equipped with an acceleration sensor capable of measuring movement of a user. The method includes the steps of: a) measuring acceleration according to a change in the location of the mobile communication terminal by the acceleration sensor and detecting acceleration values of the terminal expressed in an orthogonal coordinate system where the acceleration sensor is set to a reference position; b) calculating gravitational acceleration direction values of the acceleration of the terminal from the acceleration values of the terminal detected in step a); c) detecting relative values of the acceleration values with respect to the gravitational acceleration direction values; and d) calculating the movement amount from the detected relative values.

### FIELD OF THE INVENTION

The present invention relates to a method of measuring the amount of exercise using an acceleration sensor incorporated in a mobile communication terminal and, more particularly, to a method of measuring the amount of exercise using a mobile communication terminal equipped with an acceleration sensor capable of measuring movement of a user regardless of the direction of the acceleration sensor by automatically recognizing gravitational direction using the acceleration sensor that can measure acceleration in the directions of three axes (x, y, z).

### BACKGROUND OF THE INVENTION

In general, when there is an angular displacement in an axial direction, an acceleration sensor measures acceleration data by converting a displacement of an oscillator to an electrical signal. Such an acceleration sensor is widely used in measuring a user's behavior pattern, and is recently used in measuring a user's movement pattern.

However, there have been problems in such a conventional acceleration sensor in that different results are obtained according to the direction of the acceleration sensor and the accuracy of measurement decreases unless the acceleration sensor is located in a predetermined direction.

### SUMMARY OF THE INVENTION

The present invention provides a method of measuring the amount of exercise using a mobile communication terminal capable of preventing a decrease in the accuracy of measurement resulting from a change in the direction of an acceleration sensor by calculating the magnitude of displacement regardless of the direction of the acceleration sensor.

Further, the present invention provides a method of automatically recognizing a gravitational direction by calculating a gravitational acceleration direction regardless of the direction of a mobile communication terminal changed in real time using an acceleration sensor that can measure acceleration in three orthogonal directions.

In accordance with an aspect of the present invention, there is provided a method of measuring the amount of exercise using an acceleration sensor incorporated in a mobile communication terminal, the method comprising the steps of: a) measuring acceleration according to a change in the location of the mobile communication terminal by the acceleration sensor and detecting acceleration values C=(Cx, Cy, Cz) of the mobile communication terminal which are expressed in an orthogonal coordinate system (x,y,z) where the acceleration sensor is set to a reference position; b) calculating gravitational acceleration direction values S=(Sx, Sy, Sz) of the acceleration of the mobile communication terminal from the acceleration values C=(Cx, Cy, Cz) of the mobile communication terminal detected in step a); c) detecting relative values CS=(Cx−Sx, Cy−Sy, Cz−Sz) of the acceleration values C=(Cx, Cy, Cz) with respect to the gravitational acceleration direction values S=(Sx, Sy, Sz); and d) calculating the movement amount from the detected relative values CS.

In the step b), the gravitational acceleration direction values S=(Sx, Sy, Sz) may be calculated from a mean value of the acceleration values C=(Cx, Cy, CZ) repeatedly measured a predetermined number of times and acceleration values Cg=(Cx, Cy, Cz) of the mobile communication terminal which are subsequently newly detected.

The gravitational acceleration direction values S may be obtained by the following equation: S=mean value×0.99+Cg×0.01.

In the step d), the movement amount may be calculated by the following equation: r=CS·S/S·S where “r” denotes a projection value of CS with respect to S.

The exercise amount may be calculated from differential values between the movement amounts r which are continuously changed and detected as the mobile communication terminal moves continuously.

The running amount, one of the exercise amounts, may be counted one time when a differential value of r drops from +1 or above to −0.5 or below.

The walking amount, one of the exercise amounts, may be counted one time when a differential value of r drops to −0.2 or below and then rises to a positive value.

In accordance with another aspect of the present invention, there is provided a method of measuring a gravitational acceleration direction of a mobile communication terminal using an acceleration sensor incorporated in the mobile communication terminal, the method comprising the steps of: measuring acceleration according to a change in the location of the mobile communication terminal by the acceleration sensor; and detecting and processing an acceleration vector of the mobile communication terminal which is expressed in a coordinate system where the acceleration sensor is set to a reference position.

The gravitational acceleration direction may be obtained from a mean acceleration vector of the acceleration vectors repeatedly measured a predetermined number of times and acceleration vectors of the mobile communication terminal which are subsequently newly detected.

In general, a human's movement is relatively larger in a gravitational acceleration direction than in a back-and-forth direction. Accordingly, the present invention analyzes a user's exercise from the magnitudes of gravitational acceleration direction of running and walking patterns.

### BRIEF DESCRIPTION OF THE DRAWINGS

The present invention will become more apparent by describing in detail exemplary embodiments thereof with reference to the attached drawings in which:

FIG. 1 is a block diagram showing a mobile communication terminal in accordance with the present invention;

FIG. 2 is a view showing a directional relation between an acceleration sensor and a gravitational acceleration;

FIG. 3 is a graph showing an example of a running pattern obtained in accordance with the present invention;

FIG. 4 is a graph showing an example of a walking pattern obtained in accordance with the present invention; and

FIG. 5 is a flow chart showing a method of measuring the amount of exercise using a mobile communication terminal in accordance with the present invention.

### DETAILED DESCRIPTION OF THE PREFERRED EMBODIMENT

Exemplary embodiments in accordance with the present invention will now be described in detail with reference to the accompanying drawings.

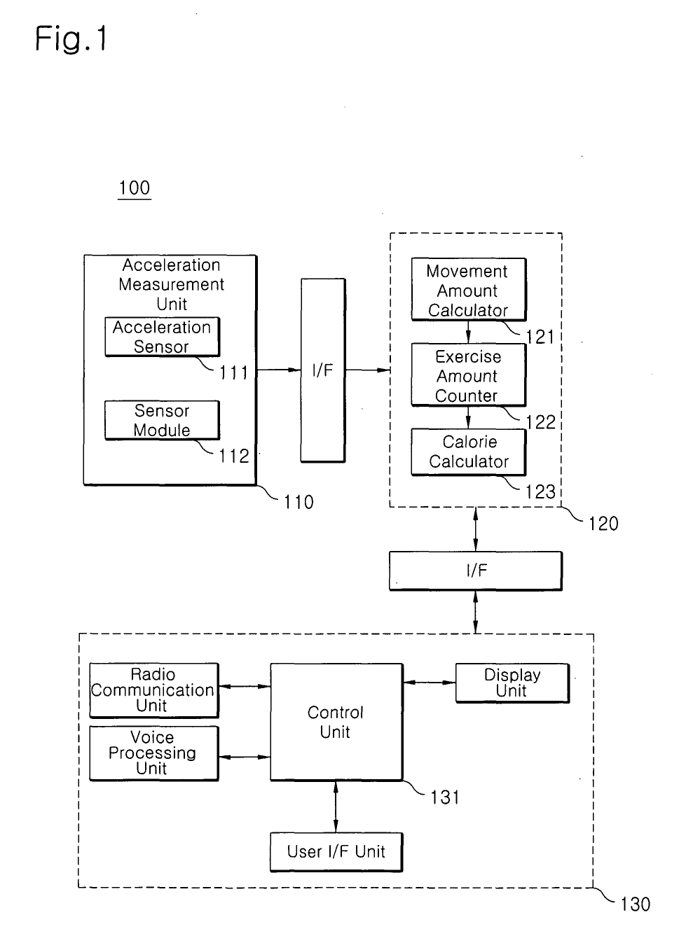

FIG. 1 is a block diagram showing a mobile communication terminal in accordance with the present invention. A mobile communication terminal 100 according to the present invention comprises an acceleration measurement unit 110 for measuring acceleration according to a movement of the mobile communication terminal 100, a movement measurement module 120 for processing the measured acceleration value, and a main body 130 of the mobile communication terminal 100.

The acceleration measurement unit 110 is incorporated in a mobile communication terminal such as mobile phone or PDA, and comprises an acceleration sensor 111 and a sensor module 112. The acceleration sensor 111 detects a change in the location or direction of the mobile communication terminal, and measures acceleration based on the change. An example of such an acceleration sensor 111 is disclosed in Korean Unexamined Patent Application Publication No. 2002-91002 and a detailed description thereof will thus be omitted herein. The sensor module 112 controls operation of the acceleration sensor 111 and converts the measured acceleration value to a digital signal.

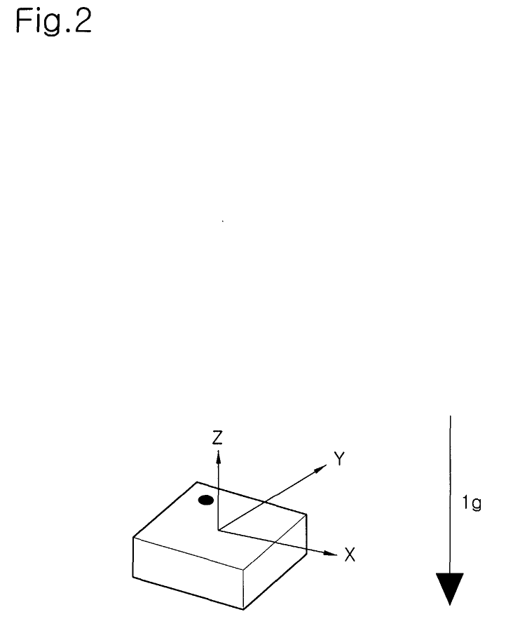

The acceleration measurement unit 110 measures acceleration based on a change in the location of a mobile communication terminal, and detects acceleration C=(Cx, Cy, Cz) with respect to each direction of an orthogonal coordinate system (x,y,z) where the acceleration sensor 111 is set as a reference position. FIG. 2 shows a directional relation between a gravitational acceleration and an acceleration sensor incorporated in a mobile communication terminal in a static state.

The movement measurement module 120 comprises a movement amount calculator 121, an exercise amount counter 122, and a calorie calculator 123. The movement amount calculator 121 calculates the movement amount of a mobile communication terminal from an acceleration value C received from the acceleration measurement unit 110 through an interface (I/F). The exercise amount counter 122 counts the exercise amount of a user, such as running amount and walking amount, from the movement amount of the mobile communication terminal calculated in the movement amount calculator 121. The calorie calculator 123 calculates the calorie consumption amount of the user from the running and walking amounts counted in the exercise amount counter 122.

The movement amount calculator 121 calculates the movement amount of the mobile communication terminal using the acceleration value C outputted from the acceleration measurement unit 110. The movement amount is calculated by considering the direction of a gravitational acceleration and the acceleration value C. As a user moves, the directions of the mobile communication terminal and the acceleration sensor incorporated in the mobile communication terminal with respect to the gravitational acceleration are accordingly changed. Since this causes the predetermined directions of the gravitational acceleration and the coordinate system to be changed, the directions should be continuously corrected. The acceleration values C=(Cx, Cy, Cz) are repeatedly measured a predetermined number of times (e.g., 99 times) in real time, and then a mean value of the measured acceleration values is stored. Subsequently, when newly detected acceleration values Cg=(Cx, Cy, Cz) of the mobile communication terminal are received, gravitational acceleration direction values S=(Sx, Sy, Sz) of the acceleration of the mobile communication terminal are obtained by processing the received acceleration values Cg. Preferably, the values S are obtained by the following equation: S=mean value×0.99+Cg×0.01. That is, while the direction of the acceleration C=(Cx, Cy, Cz) of the mobile communication terminal is continuously changed as a user moves, the direction of the gravitational acceleration can be obtained by averaging the consecutively detected values.

The movement amount calculator 121 detects relative values CS=(Cx−Sx, Cy−Sy, Cz−Sz) of the acceleration C=(Cx, Cy, Cz) of the mobile communication terminal with respect to the gravitational acceleration direction values S=(Sx, Sy, Sz), and calculates the movement amount from the detected relative values CS. The movement amount is calculated by the following equation r=CS·S/S·S where “r” designates a projection value of CS with respect to S. That is, the movement amount can be represented as a ratio of the movement distance (magnitude) in a gravitational acceleration direction of the mobile communication terminal to the gravitational acceleration.

The movement amount counter 122 receives the movement amounts r which are continuously changed and detected as the mobile communication terminal moves, and counts the exercise amount from differences between the movement amounts, i.e. differential values. The exercise amount is classified into running amount and walking amount, which are counted according to their respective features.

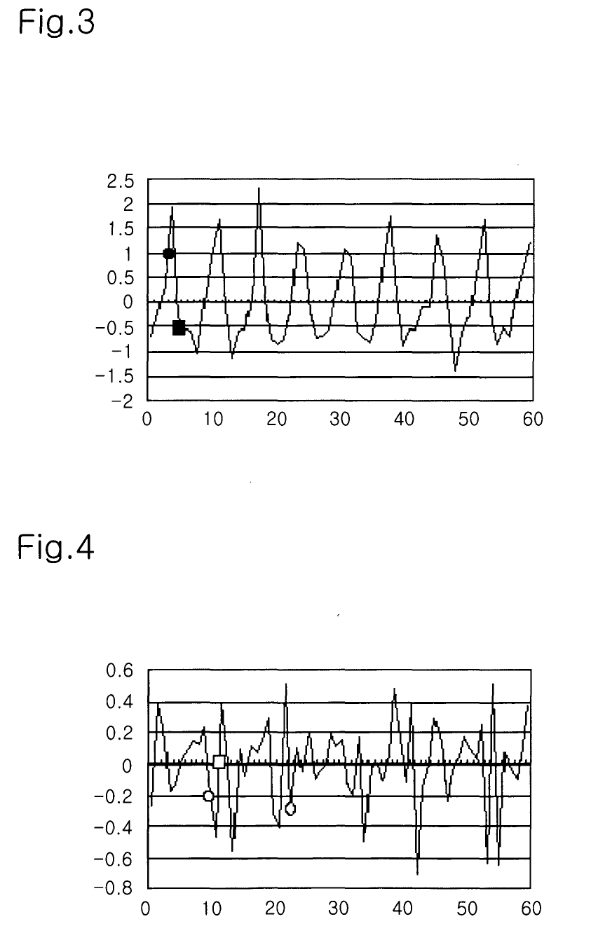

FIGS. 3a and 3b show running and walking patterns obtained according to the present invention, respectively. The graphs show differences between approximately 60 movement amounts r which are calculated in the movement amount calculator 121 and are consecutively received, i.e. differential values of r. The graphs depict the differential values of the movement amounts r rather than the movement amounts r since more accurate data can be obtained in terms of accuracy in signal processing. In the graph of FIG. 3, when a differential value of r drops from +1 () or above to −0.5 (▪) or below, the running amount is counted one time. In the graph of FIG. 4, when a differential value of r drops to −0.2 (∘) or below and then rises to a positive value (□), the walking amount is counted one time.

Meanwhile, the calorie calculator 123 calculates calorie consumption amount by aerobic exercise from the running and walking amounts obtained in the exercise amount counter 122. The following equation 1 is an example of the calculation equation.

walking_calorie=height×0.0037×0.0007399×weight×walking_amount

running_calorie=height×0.0055×0.0008586×weight×running_amount

consumption_calorie=walking_calorie+running_calorie [Equation 1]

Table 1 shows exercise amount counts calculated from acceleration data obtained from the predetermined number of running and walking times through the above-mentioned procedure. The table 1 shows that the number of counts measured according to the present invention is almost equal to the actual number of running and walking times. Accordingly, the present invention can be effectively applied to mobile communication terminals such as PDA.

TABLE 1

| | | Actual | Counted |
|---|---|---|---|
| | | Running/Walking | Running/Walking |
| | Experiments | (times) | (times) |
| Walking | First | 0/100 | 2/98 |
| | Second | 0/100 | 1/97 |
| Running | First | 100/0 | 100/2 |
| | Second | 100/0 | 99/2 |
| Combination | First | 23/32 | 23/34 |

Meanwhile, the movement amount, exercise amount, and calorie data are received through I/F from the movement measurement module 120, and are displayed on a display unit under control of the controller 131 in the main body 130.

While the acceleration measurement unit 110 and the movement measurement module 120 are externally mounted on the mobile communication terminal 100 and measurement data is transferred through the I/F in the above-mentioned embodiments, it should be understand that the present invention is not limited thereto but may be internally integrated with the main body 130 of the mobile communication terminal 100.

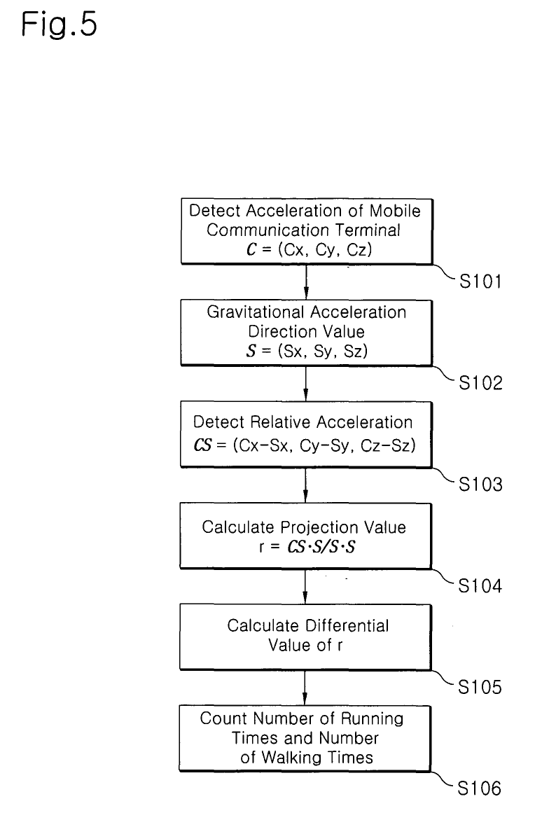

FIG. 5 is a flow chart showing a method of measuring the amount of exercise using a mobile communication terminal according to the present invention.

In a first step, acceleration according to a change in the location of a mobile communication terminal is measured by an acceleration sensor, and acceleration values C=(Cx, Cy, Cz) are detected which are expressed in an orthogonal coordinate system (x,y,z) where the acceleration sensor is set to a reference position (step S101).

In a second step, gravitational acceleration direction values S=(Sx, Sy, Sz) of the acceleration of the mobile communication terminal are calculated from the acceleration values C=(Cx, Cy, Cz) of the mobile communication terminal detected in the first step (step S102). At this time, since the direction of the mobile communication terminal and the acceleration sensor incorporated in the mobile communication terminal with respect to the gravitational acceleration is continuously changed as a user moves, the predetermined direction of the coordinate system and the gravitational acceleration is also changed and should be thus corrected continuously. The acceleration values C=(Cx, Cy, Cz) are repeatedly measured a predetermined number of times (e.g., 99 times) in real time, and then a mean value of the measured acceleration values is stored. Subsequently, when newly detected acceleration values Cg=(Cx, Cy, Cz) of the mobile communication terminal are received, gravitational acceleration direction values S=(Sx, Sy, Sz) of the acceleration of the mobile communication terminal are obtained by processing the received acceleration values Cg. Preferably, the values S are obtained by the following equation: S=mean value×0.99+Cg×0.01.

In a third step, relative values CS=(Cx−Sx, Cy−Sy, Cz−Sz) of the acceleration values C=(Cx, Cy, Cz) with respect to the gravitational acceleration direction values S=(Sx, Sy, Sz) are detected (step S103).

In a fourth step, the movement amount is calculated from the detected relative values CS. The movement amount is calculated by the following equation: r=CS·S/S·S where “r” denotes a projection value of CS with respect to S (step S104).

In a fifth step, differential values between the projection values r which are continuously changed and detected as the mobile communication terminal moves are calculated (step S105).

In a sixth step, when a differential value of r drops from +1 or above to −0.5 or below, the running amount is counted one time. When a differential value of r drops to −0.2 or below and then rises to a positive value, the walking amount is counted one time (step S106).

As apparent from the above description, since the gravitational direction is automatically recognized and only the magnitude of displacement is calculated regardless of the direction of the acceleration sensor, it is possible to prevent a decrease in the accuracy of measurement resulting from a change in the direction of the acceleration sensor.

While the present invention has been described with reference to exemplary embodiments thereof, it will be understood by those skilled in the art that various changes in form and details may be made therein without departing from the scope of the present invention as defined by the following claims.

What is claimed is:

1. A method of measuring the amount of exercise using an acceleration sensor incorporated in a mobile communication terminal, the method comprising the steps of:
a) measuring acceleration according to a change in the location of the mobile communication terminal by the acceleration sensor and detecting acceleration values C=(Cx, Cy, Cz) of the mobile communication terminal which are expressed in an orthogonal coordinate system (x,y,z) where the acceleration sensor is set to a reference position;
b) calculating gravitational acceleration direction values S=(Sx, Sy, Sz) of the acceleration of the mobile communication terminal from the acceleration values C=(Cx, Cy, Cz) of the mobile communication terminal detected in step a);
c) detecting relative values CS=(Cx−Sx, Cy−Sy, Cz−Sz) of the acceleration values C=(Cx, Cy, Cz) with respect to the gravitational acceleration direction values S=(Sx, Sy, Sz); and
d) calculating the movement amount from the detected relative values CS.

2. The method of claim 1, wherein in the step b), the gravitational acceleration direction values S=(Sx, Sy, Sz) are calculated from a mean value of the acceleration values C=(Cx, Cy, Cz) repeatedly measured a predetermined number of times and acceleration values Cg=(Cx, Cy, Cz) of the mobile communication terminal which are subsequently newly detected.

3. The method of claim 2, wherein the gravitational acceleration direction values S are obtained by the following equation: S=mean value×0.99+Cg×0.01.

4. The method of claim 1, wherein in the step d), the movement amount is calculated by the following equation: r=CS·S/S·S where “r” denotes a projection value of CS with respect to S.

5. The method of claim 4, wherein the exercise amount is calculated from differential values between the movement amounts r which are continuously changed and detected as the mobile communication terminal moves continuously.

6. The method of claim 5, wherein the exercise amount indicates running amount, and the running amount is counted one time when a differential value of r drops from +1 or above to −0.5 or below.

7. The method of claim 5, wherein the exercise amount indicates walking amount, and the walking amount is counted one time when a differential value of r drops to −0.2 or below and then rises to a positive value.

8. (canceled)

9. A method of measuring a gravitational acceleration direction of a mobile communication terminal using an acceleration sensor incorporated in the mobile communication terminal, the method comprising the steps of:
measuring acceleration according to a change in the location of the mobile communication terminal by the acceleration sensor; and
detecting and processing an acceleration vector of the mobile communication terminal which is expressed in a coordinate system where the acceleration sensor is set to a reference position;
wherein the gravitational acceleration direction is obtained from a mean acceleration vector of the acceleration vectors repeatedly measured a predetermined number of times.

10. The method of claim 9, wherein the gravitational acceleration direction is obtained from the mean acceleration vector and acceleration vectors of the mobile communication terminal which are subsequently newly detected.

11. (canceled)

12. A mobile communication terminal equipped with an acceleration sensor for measuring the amount of exercise, comprising:
an acceleration measurement unit for detecting a change in the location of the mobile communication terminal using the acceleration sensor and outputting acceleration values according to the change in the location;
a movement amount calculator for calculating the movement amount of the mobile communication terminal by processing the acceleration values;
an exercise amount counter for separately counting running amount and walking amount from the movement amount; and
a control unit for receiving and controlling ouput signals of the running and walking amounts;
wherein the movement amount calculator receives acceleration values C=(Cx, Cy, Cz) expressed in an orthogonal coordinate system (x,y,z) where the acceleration sensor is set to a reference position, and calculates gravitational aceleration direction values S=(Sx, Sy, Sz) of the acceleration values using a mean value of the acceleration values.

13. The mobile communication terminal of claim 12, wherein the movement amount calculator detects relative values CS=(Cx−Sx, Cy−Sy, Cz−Sz) of the acceleration C=(Cx, Cy, Cz) with respect to the gravitational acceleration direction values S=(Sx, Sy, Sz), and calculates movement amount from the detected relative values CS.

14. The mobile communication terminal of claim 13, wherein the movement amount is calculated by the following equation: r=CS·S/S·S where “r” denotes a projection value of CS with respect to S.

15. The mobile communication terminal of claim 14, wherein the exercise amount counter counts walking amount from differential values between the projection values r which are continuously changed and detected as the mobile communication terminal moves continuously.

16. The mobile communication terminal of claim 15, wherein the exercise amount indicates running amount, and the running amount is counted one time when a differential value of r drops from +1 or above to −0.5 or below.

17. The mobile communication terminal of claim 15, wherein the exercise amount indicates walking amount, the walking amount is counted one time when a differential value of r drops to −0.2 or below and then rises to a positive value.

18. The mobile communication terminal of any one of claims 12 to 17, further comprising a calorie calculator for calculating calorie consumption amount from the running and walking amounts.
